(19) United States
(12) Patent Application Publication
(10) Pub. No.: US 2012/0026835 A1
(43) Pub. Date: Feb. 2, 2012

(54) SUBSURFACE IMAGING METHOD USING VIRTUAL SOURCES DISTRIBUTED UNIFORMLY OVER THE SUBSURFACE

(75) Inventor: Changsoo SHIN, Seoul (KR)

(73) Assignee: SNU R&DB FOUNDATION, Seoul (KR)

(21) Appl. No.: 13/033,516

(22) Filed: Feb. 23, 2011

(30) Foreign Application Priority Data
Jul. 30, 2010 (KR) 10-2010-0074334

(51) Int. Cl. G01V 1/28

(52) U.S. Cl. 367/73

(57) ABSTRACT

There are provided a subsurface imaging apparatus and method for modeling a subsurface structure by solving a wavefield equation by waveform inversion. A virtual source that generates an observed wavefield and is distributed over grid points of the subsurface is obtained by applying a least-square method to an equation including a Green's function of the subsurface medium. Then, a subsurface model generating the observed wavefield when applying the virtual source is obtained.

### CROSS-REFERENCE TO RELATED APPLICATION

This application claims the benefit under 35 U.S.C. §119(a) of a Korean Patent Application No. 10-2010-0074334, filed on Jul. 30, 2010, the entire disclosure of which is incorporated herein by reference for all purposes.

### BACKGROUND

1. Field

The following description relates to an apparatus for imaging a subsurface structure, and more particularly, to a subsurface imaging apparatus for modeling a subsurface structure by solving a wavefield equation by waveform inversion, and a subsurface imaging method thereof.

2. Description of the Related Art

In order to explore a subsurface structure, vessels travel at sea while pulling a streamer on which receivers are mounted in a lattice shape and successively shoot air guns that are sources to measure reflected waves at the receivers. The streamer is, for example, a hydro-phone cable in which floating oil is filled. Piezo-electric receivers for sensing changes in pressure are arranged in the cable. The cable can extend to a required length and is generally composed of about 24 to 96 channels.

When a parameter of a medium generating an observed wavefield upon application of sources is calculated by waveform inversion, an iterative method of updating a parameter to minimize a residual function that is a target function has been used, however, the method requires a long time for iterative matrix computation.

### SUMMARY

The following description relates to a method of easily obtaining a medium parameter using a virtual source that generates an observed wavefield and is distributed over grid points of the subsurface.

In one general aspect, a virtual source that generates an observed wavefield and is distributed over grid points of the subsurface is obtained by applying a least-square method to an equation including a Green's function of the subsurface medium. Then, the virtual source is used to directly obtain a subsurface model generating the observed wavefield.

In another aspect, a virtual source is obtained by applying the least-square method to a matrix equation, the matrix equation representing that a difference matrix of a modeled wavefield is calculated using an initial velocity model and an observed wavefield by multiplying a Green's function matrix of the subsurface medium by a matrix of virtual sources, and solving an equation re-formulated from the resultant matrix equation by a conjugate-gradient least squares (CSLS) method or a generalized minimal residual (GMRES) method.

Also, the parameter of the subsurface medium is obtained by computation as follows. That is, a perturbation value Δu of a wavefield u modeled by a true velocity model and a true source is obtained from a virtual source vector calculated in advance, and the perturbation value Δu and a wavefield value u₀ modeled by an initial velocity model are put into an equation of a virtual source, thereby obtaining a perturbation value ΔL of an operator of a wave equation modeled by the true velocity model. Then, a velocity model of the subsurface medium is obtained based on linearity between the perturbation value ΔL and the medium parameter.

Other features and aspects will be apparent from the following detailed description, the drawings, and the claims.

### BRIEF DESCRIPTION OF THE DRAWINGS

FIG. 1 is a diagram illustrating an example of a subsurface imaging apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Wave equation modeling using a true velocity model can be expressed as

Lu=f, (1)

where L is an operator of the wave equation modeling by the true velocity model, f is a true source, and u is a modeled wavefield by the true velocity model and the true source f.

If wave equation modeling using an initial velocity model is expressed as equation (2), equation (1) can be expressed as equation (3)

L₀u₀=f. (2)

(L₀+ΔL)(u₀+Δu)=f (3)

where ΔL and Δu are perturbation terms of the modeling operator and the modeled wavefield, respectively.

Equation (3) can be rearranged as

L₀(u₀+Δu)=f−ΔL(u₀+Δu). (4)

Putting equation (4) into equation (2) yields

L₀Δu=−ΔL(u₀+Δu). (5)

The right-hand term in equation (5) is assumed to a virtual source as

\hat{f}=−ΔL(u₀+Δu). (6)

Then, equation (5) can be rewritten as

L₀Δu=\hat{f}

Meanwhile, the virtual source \hat{f} which generates the observed wavefield and is distributed over grid points of the subsurface satisfies the following relationship.

d(x′)−u₀(x′)=∫_{Ω}G(x′;x)\hat{f}(x)dΩ (7)

where d is the observed wavefield, u₀ is the modeled wavefield using the initial velocity model, x′ is a receiver point, x is grid point of the subsurface, G is a Green's function and Ω is a domain of interest.

According to an example, the virtual source \hat{f} which generates the observed wavefield and is distributed over grid points of the subsurface can be obtained by solving a matrix equation calculated by applying a least-square method to a wavefield equation including a product of a Green's function matrix of the subsurface medium and a virtual source matrix.

According to another example, the virtual source \hat{f} can be obtained by solving the calculated matrix equation by a conjugate-gradient least squares method or a generalized minimal residual (GMRES) method.

Hereinafter, a method of obtaining the virtual source \hat{f} which generates the observed wavefield and is distributed over grid points of the subsurface will be described.

Equation 7 can be expressed as the discretized matrix equation as follows. The matrix equation represents that a difference matrix of the modeled wavefield is calculated using the initial velocity model and the observed wavefield by multiplying a Green's function matrix of the medium by a matrix of virtual sources.

$$[ \begin{matrix}{G}_{11} & {G}_{12} & L & {G}_{1 n} \\ {G}_{21} & {G}_{22} & L & {G}_{1 n} \\ M & M & O & M \\ {G}_{m 1} & {G}_{m 2} & L & {G}_{mn}\end{matrix} ] [ \begin{matrix}{\hat{f}}_{1} \\ {\hat{f}}_{2} \\ M \\ {\hat{f}}_{m}\end{matrix} ] = [ \begin{matrix}{d}_{1} - {u}_{1} \\ {d}_{2} - {u}_{2} \\ M \\ {d}_{m} - {u}_{m}\end{matrix} ] \qquad ( 8 )$$

where, Gᵢⱼ is a Green's function by an impulse source of a j^{th} node at an i^{th} node, n is the number of model parameters, and m is the number of the observed data.

In the inverse problem in geophysics, the number of model parameters is usually larger than that of the observed data. Thus, the inverse problem is the underdetermined problem.

According to an example, the underdetermined problem can be solved by re-formulating the equation using the least-square method and then applying the CSLS or GMRES method that is an indirect solver.

Equation (9) can be derived by applying the least-square method to the equation (2).

$${[ \begin{matrix}{G}_{11} & {G}_{12} & L & {G}_{1 n} \\ {G}_{21} & {G}_{22} & L & {G}_{2 n} \\ M & M & O & M \\ {G}_{m 1} & {G}_{m 2} & L & {G}_{mn}\end{matrix} ]}^{*} [ \begin{matrix}{G}_{11} & {G}_{12} & L & {G}_{1 n} \\ {G}_{21} & {G}_{22} & L & {G}_{2 n} \\ M & M & O & M \\ {G}_{m 1} & {G}_{m 2} & L & {G}_{mn}\end{matrix} ] [ \begin{matrix}{\hat{f}}_{1} \\ {\hat{f}}_{2} \\ M \\ {\hat{f}}_{m}\end{matrix} ] = {[ \begin{matrix}{G}_{11} & {G}_{12} & L & {G}_{1 n} \\ {G}_{21} & {G}_{22} & L & {G}_{2 n} \\ M & M & O & M \\ {G}_{m 1} & {G}_{m 2} & L & {G}_{mn}\end{matrix} ]}^{*} [ \begin{matrix}{d}_{1} - {u}_{1} \\ {d}_{2} - {u}_{2} \\ M \\ {d}_{m} - {u}_{m}\end{matrix} ] \qquad ( 9 )$$

where, * indicates a conjugate transpose. To solve equation (9), every Green's function in the matrix equation is calculated and then two matrices of Green's functions are multiplied. Finally, the multiplied matrix is inverted to obtain the virtual source. To solve this equation by direct solver, large memory and long computation time are required.

Using the reciprocity theorem for simple computation, equation (9) can be expressed as

$${[ \begin{matrix}{G}_{11} & {G}_{21} & L & {G}_{n 1} \\ {G}_{12} & {G}_{22} & L & {G}_{n 2} \\ M & M & O & M \\ {G}_{1 m} & {G}_{2 m} & L & {G}_{nm}\end{matrix} ]}^{*} [ \begin{matrix}{G}_{11} & {G}_{21} & L & {G}_{n 1} \\ {G}_{12} & {G}_{22} & L & {G}_{n 2} \\ M & M & O & M \\ {G}_{1 m} & {G}_{2 m} & L & {G}_{nm}\end{matrix} ] [ \begin{matrix}{\hat{f}}_{1} \\ {\hat{f}}_{2} \\ M \\ {\hat{f}}_{m}\end{matrix} ] = {[ \begin{matrix}{G}_{11} & {G}_{21} & L & {G}_{n 1} \\ {G}_{12} & {G}_{22} & L & {g}_{n 2} \\ M & M & O & M \\ {G}_{1 m} & {G}_{2 m} & L & {G}_{nm}\end{matrix} ]}^{*} [ \begin{matrix}{d}_{1} - {u}_{1} \\ {d}_{2} - {u}_{2} \\ M \\ {d}_{m} - {u}_{m}\end{matrix} ] \qquad ( 10 )$$

and equation (10) can be re-written in simple form as

(̅S̅⁻̅¹̅I̅ₙ̅ₘ̅)̅(S⁻¹Iₙₘ)^{t}\hat{f}= (̅S̅⁻̅¹̅I̅ₙ̅ₘ̅)̅r (11)

where, S is a complex impedance matrix of a finite-difference method or a finite-element method, Iₙₘ is a matrix obtained by augmenting n-m null space rows to an identity matrix of Iₘₘ, \hat{f} is the virtual source vector, and r is the residual wavefield vector.

$${I}_{nm} = [ \begin{matrix}1 & 0 & L & 0 \\ 0 & 1 & L & 0 \\ M & M & O & M \\ 0 & 0 & L & 1 \\ 0 & 0 & L & 0 \\ M & M & O & M \\ 0 & 0 & L & 0\end{matrix} ]$$

Equation (11) can be reformulated to

$$\overline{{S}^{- 1}} {{I}_{nm} ( {I}_{nm} )}^{t} {S}^{- 1} \hat{f} = \overline{{S}^{- 1}} {I}_{nm} r \\ and \\ \overline{{S}^{- 1}} [ \begin{matrix}{I}_{mm} & O \\ O & O\end{matrix} ] {S}^{- 1} \hat{f} = \overline{{S}^{- 1}} [ \begin{matrix}r \\ O\end{matrix} ] , \\ and \\ \overline{( {S}^{- 1} \overline{[ \begin{matrix}{I}_{mm} & O \\ O & O\end{matrix} ] ( {S}^{- 1} \hat{f} )} )} = \overline{( {S}^{- 1} [ \begin{matrix}\overline{r} \\ \overline{O}\end{matrix} ] )} \qquad ( 12 )$$

Equation (9) derived by applying the least-square method to equation (8) representing that the difference matrix of the modeled wavefield is calculated using the initial velocity model and the observed wavefield by multiplying the Green's function matrix of the medium by the matrix of virtual sources, and equation (12) derived by reformulating equation (9) are rewritten in simpler form using the back-propagation method.

The right-hand side of equation (12) can be obtained using the conjugate of the modeled wavefield taking the conjugate of the residual wavefield as a virtual source. To calculate the left-hand side of equation (12), a source is reconfigured using values only at a receiver from a wavefield modeled to a virtual source, the reconfigured source is conjugated and modeled to obtain a wavefield and then the wavefield is conjugated. After calculating the right- and left-hand sides of equation 12, a virtual source is calculated using the CSLS or GMRES method.

To calculate the right-hand side of equation (12), the complex conjugate of

$$[ \begin{matrix}r \\ O\end{matrix} ]$$

is taken and then the conjugated vector is propagated by S⁻¹. The back-propagation method, which is a well-known method, applies numerical analysis to calculate a response with respect to a virtual medium using the matrix as a system function, instead of calculating an inverse matrix.

Finally if the complex conjugate of the propagated wavefield is taken, the right-hand term of equation (12) can be obtained.

The left-hand side of equation (12) can be calculated by two steps in the same way as the right-hand-side term. In the first step, S⁻¹\hat{f} is calculated by a modeling for a virtual source \hat{f}. In the second step, the calculated S⁻¹\hat{f} is multiplied with

$$[ \begin{matrix}{I}_{mm} & O \\ O & O\end{matrix} ] .$$

After taking a complex conjugate of

$$[ \begin{matrix}{I}_{mm} & O \\ O & O\end{matrix} ] {S}^{- 1} \hat{f} ,$$

it is propagated by S⁻¹ and finally the left-hand side can be obtained by the complex conjugation of the modeled wavefield.

By computing the left- and right-hand sides of equation (12) in these ways, the virtual source vector \hat{f} is obtained by the CSLS or GMRES method.

According to an example, a subsurface medium parameter is calculated by computation as follows. That is, a perturbation value ΔL of the modeled wavefield is calculated by the true velocity model and the true source from the virtual source vector, and a wavefield value u₀ modeled using the initial velocity model and the perturbation value Δu is put into an equation of a virtual source, thereby obtaining a perturbation value ΔL of an operator of a wave equation modeled by a true velocity model. Then, a velocity model of the subsurface medium is obtained based on linearity between the perturbation value ΔL and the medium parameter.

First, a perturbation value Δu of the modeled wavefield u is calculated by the true velocity model and true source from the virtual source vector. That is, by putting equation (5) into equation (6), the perturbation value Δu can be expressed as a modeling of a wave equation like equation (13).

L₀Δu=\hat{f} (13)

Once the virtual source \hat{f} is calculated by equation (12), Δu can be calculated by equation (13).

Then, the perturbation value Δu and the modeled wavefield u₀ by the true velocity model are put into an equation of the virtual source \hat{f} and a perturbation value ΔL of an operator of a wave equation modeled by the true velocity model is calculated. That is, the perturbation value ΔL can be obtained by putting the Δu value and the u₀ value calculated by equation (2) into equation (6) that is equation of a virtual source.

Next, a velocity model of the subsurface medium is obtained based on linearity between the perturbation value ΔL and the medium parameter. When the subsurface medium parameter is defined as a sloth (s=1/velocity), an operator of a modeling L of a wave equation can be defined as

L=K+sM (14)

where K is a stiffness matrix and M is a mass matrix.

ΔL can be defined as ΔL=K+ΔsM, like equation (14), and a perturbed sloth value can be calculated by solving a matrix equation as in

Δs=M⁻¹(ΔL−K). (15)

Since the sloth (s=1/velocity) is assumed to be linear, a true sloth value can be expressed as a sum of the initial sloth value and the perturbed sloth value.

That is, s=s₀−Δs.

Accordingly, the following relationship is satisfied.

$$\frac{1}{{v}^{2}} = \frac{1}{{v}_{0}^{2}} + \frac{1}{Δ {v}^{2}} \qquad ( 16 )$$

Therefore, a velocity model of the subsurface medium that matches the observed wavefield can be obtained by the initial s₀ for L₀ and Δs by the obtained ΔL.

Hereinafter, an example of a subsurface imaging apparatus will be described.

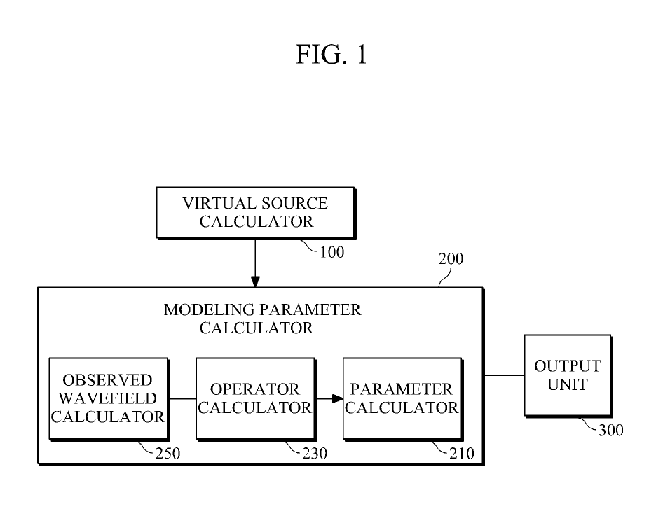

FIG. 1 is a diagram illustrating an example of a subsurface imaging apparatus. The subsurface imaging apparatus can be implemented as a computer or as a program which is executable in the computer. For fast computation, a plurality of computation factors or servers can be implemented to configure an appropriate functional block or share a part of iterative computation under a control.

The subsurface imaging apparatus includes a virtual source calculator 100 which calculates a virtual source that generates an observed wavefield and is distributed over grid points of the subsurface by solving a matrix equation derived by applying the least-square method to a wavefield equation including a product of a Green's function matrix of the subsurface medium and a virtual source matrix, and a modeling parameter calculator 200 which obtains a subsurface model generating the observed wavefield when applying the virtual source.

According to an example, the virtual source calculator 100 solves the derived matrix equation by the CSLS or GMRES method.

According to an example, the modeling parameter calculator 200 includes an observed wavefield calculator 250 which obtains a perturbation value Δu of a modeled wavefield u by a true velocity model and a true source from a calculated virtual source vector, an operator calculator 230 which puts the perturbation value Δu and the modeled wavefield u₀ by an initial velocity model into an equation of a virtual source to obtain a perturbation value ΔL of an operator of a wave equation modeled by a true velocity model, and a parameter calculator 210 which obtains a velocity model of the subsurface medium as a modeling parameter based on linearity between the perturbation value ΔL and the medium parameter.

The observed wavefield calculator 250 uses the virtual source vector calculated by equation (13) to obtain the perturbation value Δu of the modeled wavefield u by the true velocity model and true source.

The operator calculator 230 puts the perturbation value Δu and the wavefield u₀ obtained by equation (2) and modeled using the initial velocity model into equation (6) of a virtual source to calculate the perturbation value ΔL of the operator of the wave equation modeled by the true velocity model.

The parameter calculator 210 obtains a velocity model of the subsurface medium based on linearity between the calculated ΔL and the medium parameter. That is, the parameter calculator 210 can obtain a velocity model of the subsurface medium that matches the observed wavefield by the initial s₀ for L₀ and Δs by the obtained ΔL.

According to an example, the subsurface imaging apparatus can further include an output unit 300 which outputs the obtained modeling parameter in the form of visualized information. The output unit 300 can include a computer graphic module and hardware that maps the obtained modeling parameter to a predetermined value and outputs the mapped value. For example, when the obtained modeling parameter is a velocity value, the output unit 300 can map the velocity value to a color value according to its magnitude and output the color value.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A subsurface imaging method comprising:
calculating a virtual source that generates an observed wavefield and is distributed over grid points of the subsurface, by solving a matrix equation derived by applying a least-square method to a wavefield equation including a product of a Green's function matrix of the subsurface medium and a virtual source matrix; and
obtaining a subsurface model generating the observed wavefield when applying the virtual source.

2. The subsurface imaging method of claim 1, wherein the calculating of the virtual source comprises solving the derived matrix equation by a conjugate-gradient least squares (CSLS) method or a generalized minimum residual (GMRES) method.

3. The subsurface imaging method of claim 1, wherein the matrix equation derived by applying the least-square method is:
$$\overline{{S}^{- 1}} [ \begin{matrix}{I}_{mm} & O \\ O & O\end{matrix} ] {S}^{- 1} \hat{f} = \overline{{S}^{- 1}} [ \begin{matrix}r \\ O\end{matrix} ] ,$$
where S is a complex impedance matrix of a finite-difference method, \hat{f} is a virtual source vector, and r is a residual wavefield vector.

4. The subsurface imaging method of claim 1, wherein the obtaining of the subsurface model generating the observed wavefield comprises calculating a subsurface parameter,
wherein the calculating of the subsurface parameter comprises:
calculating a perturbation value Δu of a modeled wavefield u by a true velocity model and a true source from a calculated virtual source vector;
putting the perturbation value Δu and a wavefield u₀ modeled by an initial velocity model into an equation of the virtual source to calculate a perturbation value ΔL of an operator of a wave equation modeled by a true velocity model; and
calculating a velocity model of the subsurface medium based on linearity between the perturbation value ΔL and a medium parameter.

5. A subsurface imaging apparatus comprising:
a virtual source calculator configured to calculate a virtual source that generates an observed wavefield and is distributed over grid points of the subsurface, by solving a matrix equation derived by applying a least-square method to a wavefield equation including a product of a Green's function matrix of the subsurface medium and a virtual source matrix; and
a modeling parameter calculator configured to calculate a subsurface model generating the observed wavefield when applying the virtual source.

6. The subsurface imaging apparatus of claim 5, wherein the virtual source calculator calculates the virtual source by solving the derived matrix equation by a conjugate-gradient least squares (CSLS) method or a generalized minimal residual (GMRES) method.

7. The subsurface imaging apparatus of claim 5, wherein the modeling parameter calculator comprises:
an observed wavefield calculator configured to calculate a perturbation value Δu of a wavefield u modeled by a true velocity model and a true source from a calculated virtual source vector;
an operator calculator configured to put the perturbation value Δu and a wavefield u₀ modeled by an initial velocity model into an equation of the virtual source to calculate a perturbation value ΔL of an operator of a wave equation modeled by a true velocity model; and
a parameter calculator configured to calculate a velocity model of the subsurface medium based on linearity between the perturbation value ΔL and a medium parameter.

8. The subsurface imaging apparatus of claim 5, further comprising an output unit configured to output the modeling parameter in a form of visualized information.
